(19) United States
(12) Patent Application Publication
(10) Pub. No.: US 2008/0274338 A1
(43) Pub. Date: Nov. 6, 2008

(54) WIRING SUBSTRATE AND METHOD FOR MANUFACTURING THE SAME

(75) Inventors: Toshihiko KANEDA, Hakusan-shi (JP); Satoshi KIMURA, Fujimi-machi (JP); Hidemichi FURIHATA, Chino-shi (JP); Jun AMAKO, Matsumoto-shi (JP); Daisuke SAWAKI, Shiojiri-shi (JP); Takeshi KIJIMA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/056,959

(22) Filed: Mar. 27, 2008

(30) Foreign Application Priority Data
Apr. 2, 2007 (JP) 2007-096398

(51) Int. Cl. B32B 15/02; B05D 3/12

(52) U.S. Cl. 428/195.1; 427/443.1; 427/277

(57) ABSTRACT

A method for manufacturing a wiring substrate includes the steps of: (a) forming a sacrificial layer in a first pattern on a substrate; (b) forming a catalyst layer in a second pattern on the substrate; (c) immersing the substrate in an electroless plating liquid, thereby depositing a metal layer on the catalyst layer in the second pattern; and (d) heating to remove the sacrificial layer and to form a metal layer in a third pattern, wherein the third pattern is a region where the first pattern and the second pattern overlap each other.

The entire disclosure of Japanese Patent Application No. 2007-096398, filed Apr. 2, 2007 is expressly incorporated by reference herein.

### BACKGROUND

1. Technical Field

The present invention relates to wiring substrates and methods for manufacturing the same.

2. Related Art

When forming metal wirings on a substrate, for example, a subtractive method is used. According to the subtractive method, a metal layer is formed over the entire surface of the substrate, photoresist is coated on the metal layer and patterned, and the metal layer is etched by using the photoresist as a mask. This method requires a vacuum apparatus. Also, because the pattern accuracy of the metal layer depends on the photoresist pattern accuracy, it was difficult to form nano-level fine patterns with good accuracy. For example, JP-A-10-65315 is an example of related art.

### SUMMARY

In accordance with an advantage of some aspects of the invention, it is possible to provide wiring substrates on which metal layers of nano-level fine patterns are locally, accurately formed, and methods for manufacturing such wiring substrates.

A method for manufacturing a wiring substrate in accordance with a first embodiment of the invention includes the steps of: (a) forming a sacrificial layer in a first pattern on a substrate; (b) forming a catalyst layer in a second pattern on the substrate; (c) immersing the substrate in an electroless plating liquid, thereby depositing a metal layer on the catalyst layer in the second pattern; and (d) heating to remove the sacrificial layer and to form a metal layer in a third pattern, wherein the third pattern is a region where the first pattern and the second pattern overlap each other.

In the method for manufacturing a wiring substrate in accordance with the first embodiment, the step (b) may include forming a catalyst adsorbing layer including a surfactant or a silane coupling agent over the entire surface of the substrate, forming a catalyst layer on the catalyst adsorbing layer, irradiating light to a region other than the second pattern, thereby decomposing a portion of the catalyst adsorbing layer to form a catalyst layer in the second pattern.

In the method for manufacturing a wiring substrate in accordance with the first embodiment, the step (b) may include forming a catalyst adsorbing layer including a surfactant or a silane coupling agent over the entire surface of the substrate, irradiating light to a region other than the second pattern, thereby decomposing a portion of the catalyst adsorbing layer to form a catalyst adsorbing layer in the second pattern, and forming a catalyst layer on the catalyst adsorbing layer.

The method for manufacturing a wiring substrate in accordance with the first embodiment may further include, after the step (d), discharging a metal solution onto the substrate by a droplet discharging method, and hardening the metal solution to form a metal layer in a fourth pattern, wherein the fourth pattern may have a region that overlaps a portion of the third pattern.

The method for manufacturing a wiring substrate in accordance with the first embodiment may further include, after the step (d), forming a catalyst layer in a fourth pattern, and immersing the substrate in an electroless plating liquid to deposit a metal layer in the fourth pattern, wherein the fourth pattern may have a region that overlaps a portion of the third pattern.

In the method for manufacturing a wiring substrate in accordance with the first embodiment, before forming a catalyst layer in the fourth pattern, a surface of the metal layer in the third pattern may be covered by a metal layer of a material different from a material of the metal layer in the third pattern.

In the method for manufacturing a wiring substrate in accordance with the first embodiment, in the step (d), the metal layer is moved by heating into the third pattern.

In the method for manufacturing a wiring substrate in accordance with the first embodiment, in the step (d), the sacrificial layer may be decomposed and removed by heating.

In the method for manufacturing a wiring substrate in accordance with the first embodiment, the first pattern and the third pattern may include a stripe pattern having a plurality of linear lines, wherein each of the linear lines may have a line width between 10 nm and 100 nm.

In the method for manufacturing a wiring substrate in accordance with the first embodiment, the sacrificial layer may be formed from resin.

In the method for manufacturing a wiring substrate in accordance with the first embodiment, the step (a) may include coating a resin material in a flowable state on the substrate, pressing a nano-stamper having a concave pattern in the first pattern against the substrate, thereby transferring the first pattern to the resin material, and hardening the resin material.

In the method for manufacturing a wiring substrate in accordance with the first embodiment, the sacrificial layer may be formed from photoresist, and the sacrificial layer may be formed by an interference exposure method in the step (a).

A method for manufacturing a wiring substrate in accordance with a second embodiment of the invention includes the steps of: (a) forming a sacrificial layer in a first pattern on a substrate; (b) forming a metal layer above a forming region and a non forming region of the sacrificial layer; (c) heating to remove the sacrificial layer and form a metal layer in a third pattern; and (d1) discharging a metal solution onto the substrate by a droplet discharging method, and hardening the metal solution to form a metal layer in a fourth pattern, wherein the third pattern is in a region of the first pattern, and the fourth pattern includes a part of a region of the third pattern.

A method for manufacturing a wiring substrate in accordance with a third embodiment of the invention includes the steps of: (a) forming a sacrificial layer in a first pattern on a substrate; (b) forming a metal layer above a forming region and a non forming region of the sacrificial layer; (c) heating to remove the sacrificial layer and form a metal layer in a third pattern; and (d2) forming a catalyst layer in a fourth pattern, and immersing the substrate in an electroless plating liquid, thereby depositing a metal layer in the fourth pattern, wherein the fourth pattern includes a part of a region of the third pattern.

In the method for manufacturing a wiring substrate in accordance with the third embodiment, before the step (d2), a surface of the metal layer in the third pattern may be covered by a metal layer of a material different from a material of the metal layer in the third pattern.

In the method for manufacturing a wiring substrate in accordance with the third or fourth embodiment, the step (b) may include: immersing the substrate in a catalyst adsorbing solution including a surfactant or a silane coupling agent, thereby forming a catalyst adsorbing layer, and immersing the substrate in a catalyst solution, thereby forming a catalyst layer on the catalyst adsorbing layer.

In the method for manufacturing a wiring substrate in accordance with the third or fourth embodiment, the metal layer may be moved by heating into the third pattern in the step (c).

In the method for manufacturing a wiring substrate in accordance with the third or fourth embodiment, the sacrificial layer may be decomposed and removed by heating in the step (c).

A wiring substrate in accordance with a fifth embodiment of the invention pertains to a wiring substrate having a metal layer formed by an electroless plating method, and includes: a substrate; and a stripe pattern section formed on the substrate, the stripe pattern section having a plurality of linear first metal layers, wherein the stripe pattern section is provided only in a partial region on the substrate, and the first metal layer has a line width between 10 nm and 100 nm.

The wiring substrate in accordance with the fifth embodiment may further include a second metal layer that is adjacent to at least a portion of the first metal layer, and formed on a linear line having a line width between 10 μm and 100 μm.

A wiring substrate in accordance with a sixth embodiment of the invention pertains to a wiring substrate having a metal layer formed by an electroless plating method, and includes: a substrate; a stripe pattern section formed on the substrate, and having a plurality of linear first metal layers; and a second metal layer that is formed on the substrate, and contacts at least a portion of the first metal layer, wherein the second metal layer is formed in a linear line shape having a line width between 10 μm and 100 μm, and the first metal layer has a line width between 10 nm and 100 nm.

In the wiring substrate in accordance with the fifth or sixth embodiment of the invention, a gap between the first metal layers in the same direction as the line width direction may be between 70 nm and 140 nm.

In the wiring substrate in accordance with the fifth or sixth embodiment of the invention, the metal layer may be formed from platinum.

### BRIEF DESCRIPTION OF THE DRAWINGS

FIG. 1 is a schematic plan view of a wiring substrate in accordance with an embodiment of the invention.

FIG. 2 is a schematic cross-sectional view of the wiring substrate in accordance with the present embodiment.

FIG. 3 is a view showing a step of a method for manufacturing a wiring substrate in accordance with an embodiment of the invention.

FIG. 4 is a view showing a step of the method for manufacturing a wiring substrate in accordance with the embodiment of the invention.

FIG. 5 is a view showing a step of the method for manufacturing a wiring substrate in accordance with the embodiment of the invention.

FIG. 6 is a view showing a step of the method for manufacturing a wiring substrate in accordance with the embodiment of the invention.

FIG. 7 is a view showing a step of the method for manufacturing a wiring substrate in accordance with the embodiment of the invention.

FIG. 8 is a view showing a step of the method for manufacturing a wiring substrate in accordance with the embodiment of the invention.

FIG. 9 is a view showing a step of the method for manufacturing a wiring substrate in accordance with the embodiment of the invention.

FIG. 10 is a view showing a step of the method for manufacturing a wiring substrate in accordance with the embodiment of the invention.

FIG. 11 is a view showing a step of the method for manufacturing a wiring substrate in accordance with the embodiment of the invention.

FIG. 12 is a view showing a step of the method for manufacturing a wiring substrate in accordance with the embodiment of the invention.

FIG. 13 is a view showing a step of the method for manufacturing a wiring substrate in accordance with the embodiment of the invention.

FIG. 14 is a view showing a step of the method for manufacturing a wiring substrate in accordance with the embodiment of the invention.

FIG. 15 is a view showing a step of the method for manufacturing a wiring substrate in accordance with the embodiment of the invention.

FIG. 16 is a view showing a step of the method for manufacturing a wiring substrate in accordance with the embodiment of the invention.

FIG. 17 is a view showing a step of the method for manufacturing a wiring substrate in accordance with the embodiment of the invention.

FIG. 18 is a view showing a step of the method for manufacturing a wiring substrate in accordance with the embodiment of the invention.

FIG. 19 is a view showing a step of the method for manufacturing a wiring substrate in accordance with the embodiment of the invention.

FIG. 20 is a view showing a step of the method for manufacturing a wiring substrate in accordance with the embodiment of the invention.

FIG. 21 is a schematic cross-sectional view of a wiring substrate in accordance with a modified example.

FIG. 22 is a view showing a step of a method for manufacturing a wiring substrate in accordance with the modified example.

FIG. 23 is a view showing a step of the method for manufacturing a wiring substrate in accordance with the modified example.

FIG. 24 is a view showing a step of the method for manufacturing a wiring substrate in accordance with the modified example.

FIG. 25 is a view showing a step of a method for manufacturing a wiring substrate in accordance with the modified example.

FIG. 26 is a SEM image showing a wiring substrate in accordance with an experimental example.

FIG. 27 is a SEM image showing a wiling substrate in accordance with an experimental example.

FIG. 28 is a SEM image showing a wiring substrate in accordance with an experimental example.

FIG. 29 is a view showing an example of an electronic device using a wiring substrate in accordance with the embodiment of the invention.

### DESCRIPTION OF EXEMPLARY EMBODIMENTS

Preferred embodiments of the invention are described below with reference to the accompanying drawings.

1. Wiring Substrate

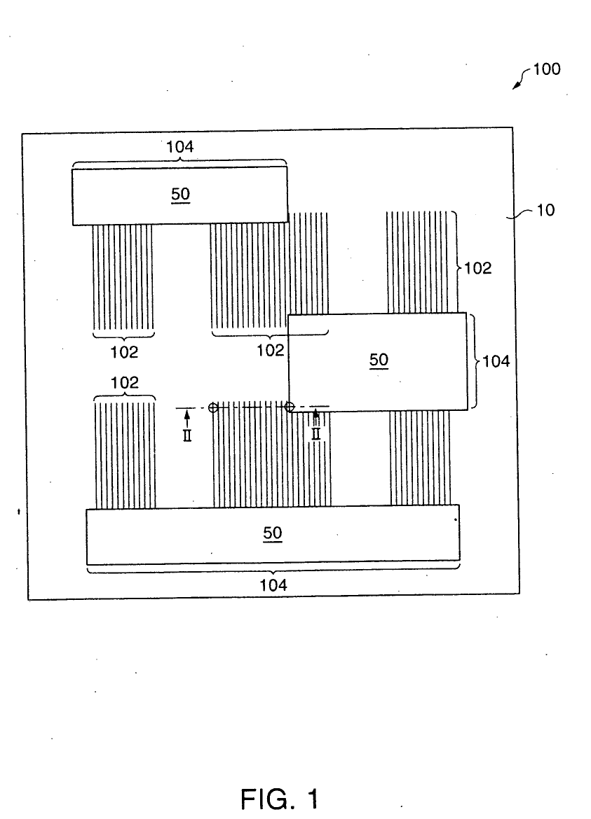

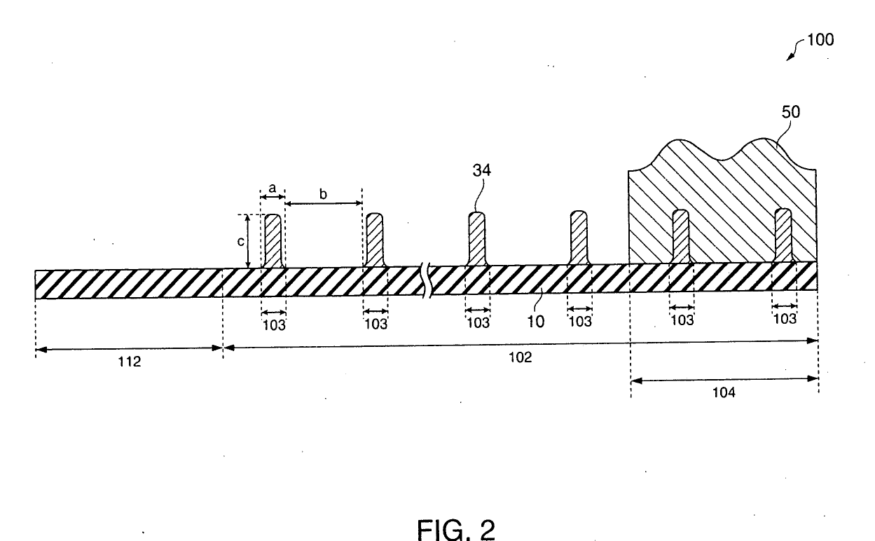

FIG. 1 and FIG. 2 schematically show a wiring substrate 100 in accordance with an embodiment of the invention. FIG. 1 is a schematic plan view of the wiring substrate 100 in accordance with the present embodiment, and FIG. 2 is a schematic cross-sectional view of the wiring substrate 100 in accordance with the present embodiment. FIG. 2 is a cross-sectional view taken along a line II-II of FIG. 1 in circled regions, and FIG. 2 omits illustration of an area between the circled regions.

The wiring substrate 100 includes a substrate 10, a first metal layer 34 and a second metal layer 50 provided on the substrate 10.

The first metal layer 34 has a third pattern. The third pattern may be a one-dimensional or a two-dimensional cyclic pattern, and may be, for example, a stripe pattern with a plurality of linear lines arranged in parallel with one another. The first metal layers 34 in the third pattern may be formed in plural regions 103, and may be formed locally in some regions 102, but not over the entire surface of the substrate 10, as shown in FIG. 1.

The first metal layer 34 has a line width a that may be between 10 nm and 100 nm, and more preferably between 10 nm and 80 nm. Also, the metal layer 34 has a height c that may be, for example, between 60 nm and 140 nm. Also, a gap b between the first metal layers 34 in a direction orthogonal to the stripe shapes in the region 102 may preferably be between 70 nm and 140 nm. Also, the line width a of the first metal layer 34 may preferably be smaller than the gap b. As a result, the adjacent ones of the metal layers 34 can be securely disconnected from each other.

By forming the first metal layers 34 in such a fine pattern, a higher integration can be achieved in electronic devices that use the wiring substrate 100, and further size-reduction of the devices can be realized.

The second metal layer 50 has a fourth pattern, and is formed in an area where the fourth pattern overlaps at least a portion of the region of the first metal layer 34. The second metal layer 50 is formed linearly, for example, in a direction traversing the first metal layers 34, and its line width d may be, for example, between 10 μm and 100 μm. In other words, the line width d of the second metal layer 50 may be about 1000 times the line width a of the first metal layer. In this manner, the wiring substrate 100 is equipped with the first metal layers 34 that are nano-level wires and the second metal layers 50 that are micro-level wires, and therefore can appropriately function as a wiring substrate of an electronic device; and the electronic device can be reduced in size.

It is noted that the wiring substrate 100 can also function as an optical wiring substrate, such as, a polarizing plate, when the first metal layers 34 in the third pattern are provided on an optically transparent substrate. For example, when the pitch of the first metal layer 34 in a periodic direction is less than the wavelength of visible rays, and the substrate 10 is formed from an optically transparent substrate, the wiring substrate 100 can function as a polarization plate.

2. Method for Manufacturing Wiring Substrate

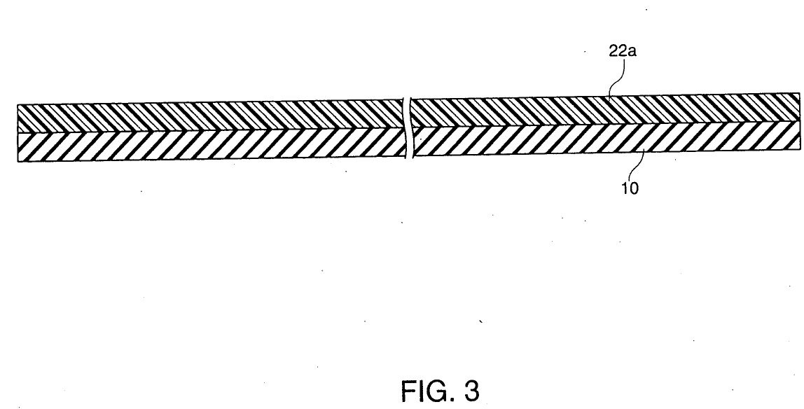

Next, a method for manufacturing a wiring substrate is described. FIGS. 3-20 are views showing the method for manufacturing a wiring substrate 100 in accordance with the present embodiment, which correspond to the cross section shown in FIG. 2, respectively.

(1) First, a substrate 10 is prepared. The substrate 10 may be an insulating substrate. By forming metal layers on the insulating substrate through the steps described below, a wiring substrate can be manufactured.

The substrate 10 may be an inorganic material substrate (for example, a quartz glass plate, a silicon wafer, an oxide layer or the like), or an organic material substrate, such as, a resin substrate or the like. The substrate 10 may not only be in a single layer, but also in a multilayer in which at least one insulation layer is formed on a base substrate. The surface of the substrate 10 may not preferably have any roughness. If such roughness exists, the height of the roughness may preferably be less than 10 nm.

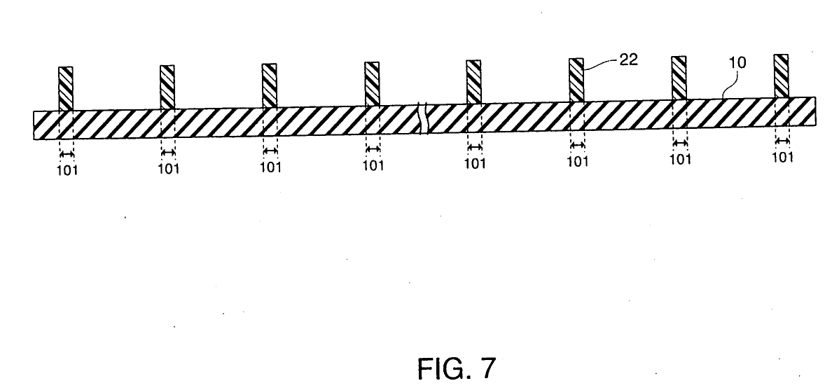

(2) Then, a sacrificial layer 22 in a first pattern is formed on the substrate 10. The first pattern may be, for example, a periodic pattern of plural lines arranged at predetermined intervals, and may be in a stripe pattern according to a specific example. The line width of each of the lines of the stripe pattern may be, for example, 70 nm, and the interval of the lines of the stripe pattern may be 140 nm. Also, the sacrificial layer 22 in the first pattern is formed over the entire surface of the substrate 10, and is formed in each region 101, as shown in FIG. 7.

As the material for the sacrificial layer 22, any material that can readily be formed, and can be removed by a heat treatment, can be used without any particular limitation. The materials that satisfy the aforementioned conditions may be resins, such as, photoresist, thermoplastic resin, photosetting resin and the like, and may preferably be those that gasify at 300° C. to 400° C. Concretely, as the material for the sacrificial layer 22, polymethylmethacrylate (PMMA), polycarbonate, and polystyrene may be used. The sacrificial layer 22 may be formed by a known method, including, for example, an interference exposure method, a nanoimprint method or the like. In accordance with the present embodiment, the case where the sacrificial layer 22 is formed by a nanoimprint method is described.

First, as shown in FIG. 3, a resin material 22a in a flowable state is coated on the entire surface of the substrate 10. As the resin material 22a, a thermoplastic resin, a photosetting resin or the like may be used. The coating method may be performed by a known method, such as, a spin coat method, a dip coat method or the like.

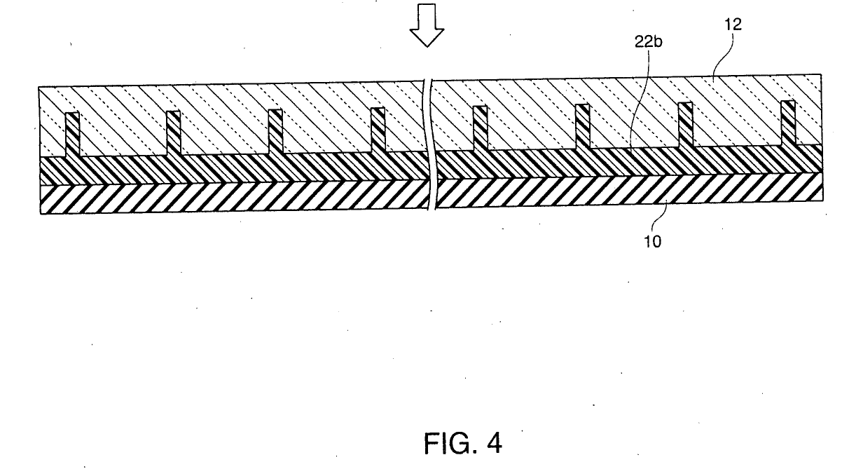

Then, a nanostamper 12 is pressed against the substrate 10 (in a direction indicated by an arrow in FIG. 4), thereby transferring a first pattern to the resin material. When the resin material 22a is a photosetting resin, the nanostamper 12 that is optically transparent may be used.

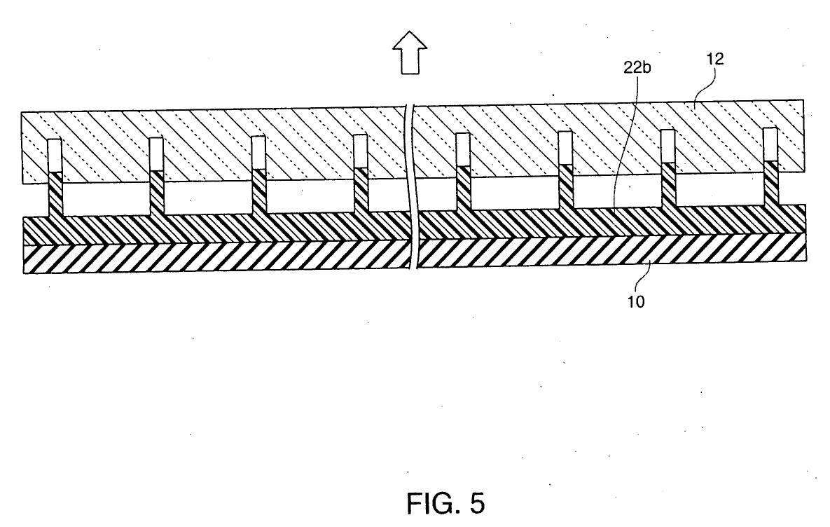

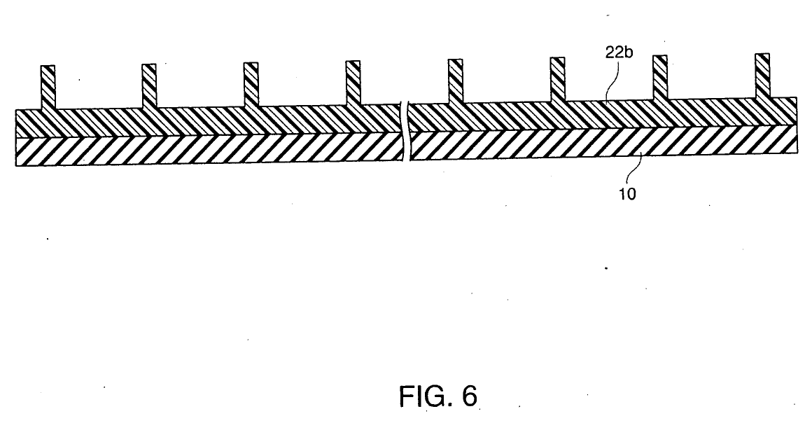

Then, the resin material 22a is hardened, whereby a sacrificial layer 22b is formed. Then, the nanostamper 12 is separated from the sacrificial layer 22b (see FIG. 5). In this manner, the sacrificial layer 22b having the first pattern can be formed, as shown in FIG. 6.

With the sacrificial layer 22b thus formed, the step (3) to be described below may be conducted. However, portions of the sacrificial layer 22b in gaps of the first pattern may be removed by etching back or the like, as shown in FIG. 7. When the sacrificial layer 22b is formed from photoresist, portions thereof may be removed by ashing. In this step, the portions of the sacrificial layer 22b in gaps of the first pattern as well as upper portions of the sacrificial layer 22b formed in regions 101 of the first pattern are removed. By conducting this removal step, a sacrificial layer 22 is formed.

The method for forming the sacrificial layer 22 using a nanoimprint method may be conducted in a manner described above. However, the sacrificial layer 22 may also be formed by using an interference exposure method, as mentioned above. When the interference exposure method is used, photoresist may be used as the resin material 22a, and a reflection prevention film may be provided in advance on the substrate 10.

(3) Next, the surface of the substrate 10 and the sacrificial layer 22 is washed. The washing of the surface of the substrate 10 and the sacrificial layer 22 may be performed by dry washing or wet washing, but may preferably be performed by dry washing. With dry washing, damage that may be inflicted on the sacrificial layer 22, such as, exfoliation can be prevented.

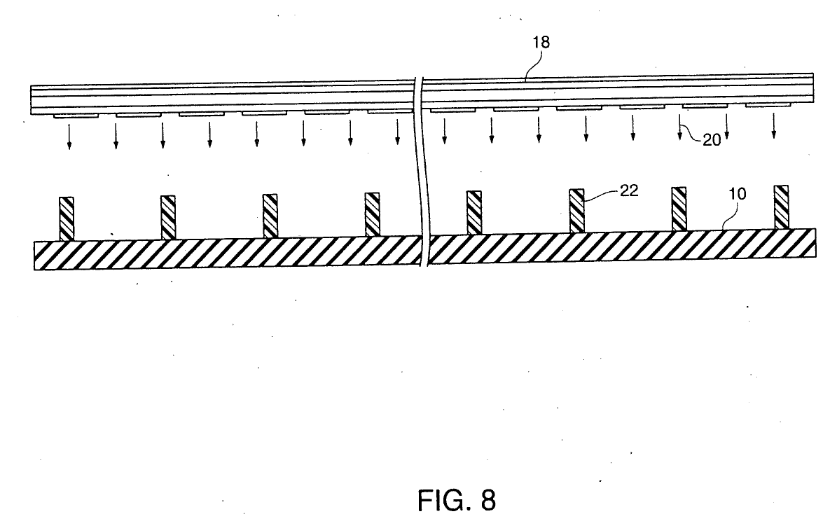

The dry washing may be performed by irradiating vacuum ultraviolet rays 20 in a nitrogen atmosphere for 30 seconds to 900 seconds, using a vacuum ultraviolet lamp (wavelength: 172 nm, output: 10 mW, distance to sample: 1 mm) 18, as shown in FIG. 8. By washing the substrate 10, dirt such as grease adhered to the surface of the substrate 10 can be removed.

The wet washing may be performed by, for example, immersing the substrate 10 in ozone water (with the ozone concentration being 10 ppm to 20 ppm) at room temperature for about 5 minutes to 30 minutes.

(4) Next, a catalyst adsorbing layer 24 including a surfactant or a silane coupling agent is formed on the substrate 10.

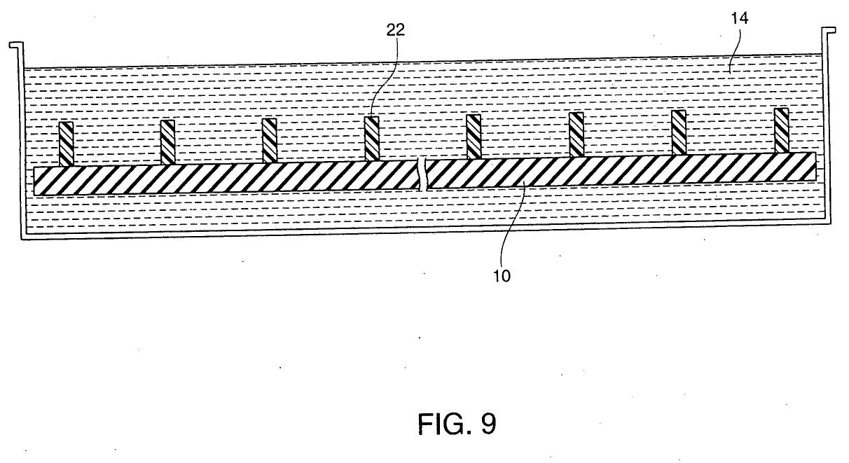

First, as shown in FIG. 9, the substrate 10 is immersed in a catalyst adsorbing solution 14 that dissolves a surfactant or a silane coupling agent. When the surface potential in liquid of the surface of the substrate 10 is a negative potential, a cationic surfactant may preferably be used, because the cationic surfactant would more likely be adsorbed to the substrate 10, compared to other surfactants. As the cationic surfactant, for example, water-soluble surfactants including aminosilane compositions and alkylammonium surfactants (such as, for example, cetyltrimethylammonium chloride, cetyl trimethylammonium bromide, and cetyldimethylammonium bromide, etc.) may be used.

As the silane coupling agent included in the catalyst adsorbing solution 14, for example, hexamethyldisilazane may be used. The immersing time may be, for example, about 1 minute to 10 minutes.

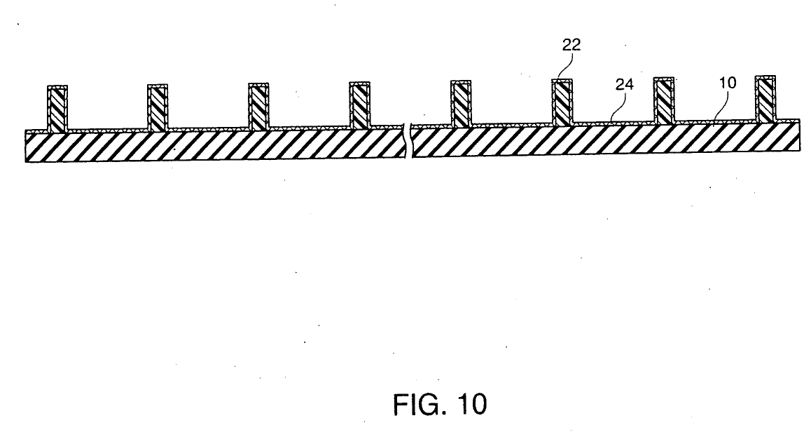

Then, the substrate 10 is removed from the catalyst adsorbing solution 14, and washed with ultrapure water. Then, the substrate 10 may be, for example, naturally dried in room temperature, or droplets on its surface may be removed by blowing compressed air, and then placed and dried in an oven at 90° C. to 120° C. for about 10 minutes to one hour. By the steps described above, the catalyst adsorbing layer 24 can be provided on the substrate 10, as shown in FIG. 10. At this moment, the surface potential in liquid of the substrate 10 is shifted more to the positive potential side than before the adsorption, when a cationic surfactant is used as the surfactant.

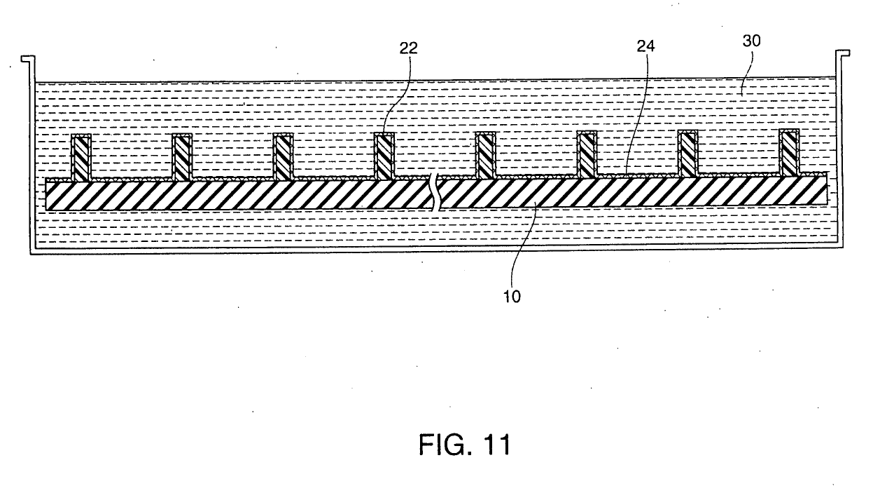

(5) Next, a catalyst layer 31 is formed on the catalyst adsorbing layer 24. First, as shown in FIG. 11, the substrate 10 is immersed in a catalyst solution 30. The catalyst solution 30 contains a catalyst composition that functions as an electroless plating catalyst. As the catalyst composition, for example, palladium may be used.

For example, the catalyst solution 30 may be prepared in the following manner.

(5a) Palladium pellets with 99.99% purity are dissolved in a mixed solution of hydrochloric acid, hydrogen peroxide solution and water, to prepare a palladium chloride solution with palladium concentration being 0.1 to 0.5 g/l.

(5b) The palladium chloride solution is further diluted with water and hydrogen peroxide solution to adjust the palladium concentration at 0.01-0.05 g/l.

(5c) The pH of the palladium chloride solution is adjusted to 4.5 to 6.8 using a sodium hydroxide aqueous solution or the like.

The substrate 10 may be washed with water after it has been immersed in the catalyst solution 30. The substrate may be washed with pure water. By washing the substrate 10 with water, catalyst residue can be prevented from being mixed into an electroless plating solution to be described below.

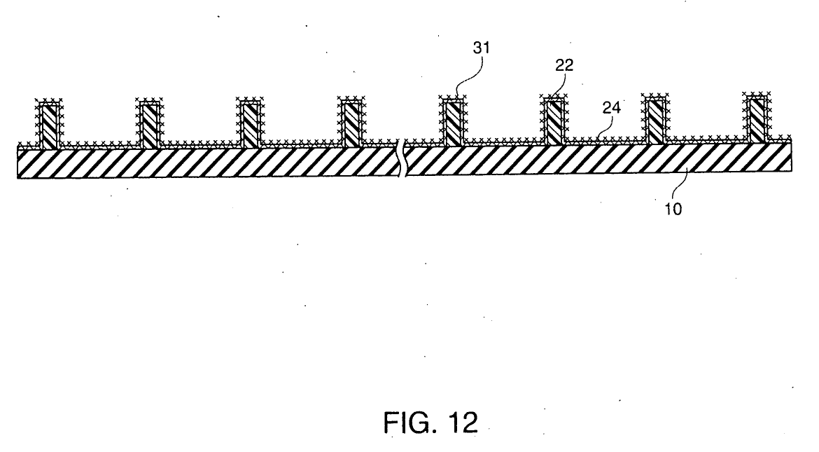

A catalyst layer 31 is formed by the above steps. As shown in FIG. 12, the catalyst layer 31 is formed on the top surface of the catalyst adsorbing layer 24 formed on the substrate 10 and the sacrificial layer 22.

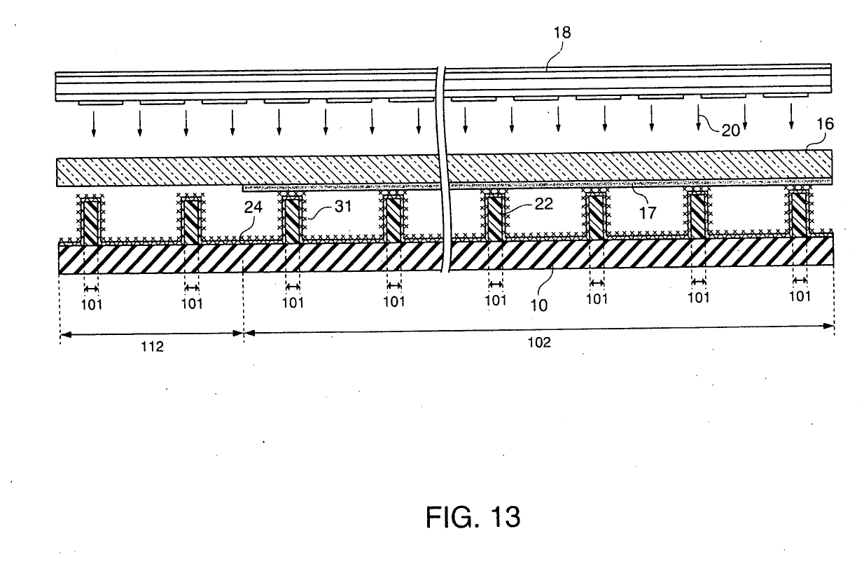

(6) Next, the catalyst layer 31 is patterned into a second pattern, whereby the catalyst layer 31 in a region 112 is removed. The second pattern corresponds to a region 102 in FIG. 13, and the patterning is conducted by irradiating light to the region 112 other than the region 102, thereby decomposing the catalyst adsorbing layer 24.

As the light 20 that is irradiated to the region 112, for example, vacuum ultraviolet (VUV) radiation may be used. The light 20 with a wavelength being set, for example, at 170 nm to 260 nm can cut interatomic bonds (for example, C—C, C ═C, C—H, C—F, C—Cl, C—O, C—N, C═O, O═O, 0—H, H—F, H—Cl, and N—H). As a result, the catalyst adsorbing layer 24 can be photodecomposed. Also, by using the light 20 with the aforementioned wavelength band, it becomes unnecessary to provide a yellow room or the like, whereby a series of steps according to the present embodiment can be performed under white light, for example.

More specifically, irradiation of the light 20 may be performed, for example, using a vacuum ultraviolet lamp (wavelength: 172 nm, output: 10 mW, distance to sample: 1 mm) as a light source 18, in a nitrogen atmosphere for 5 minutes to 30 minutes. The light source 18 may be, for example, an excimer lamp containing Xe gas. It is noted that the wavelength of the light 20 may not be particularly limited, as long as the light 20 can photodecompose the catalyst adsorbing layer 24.

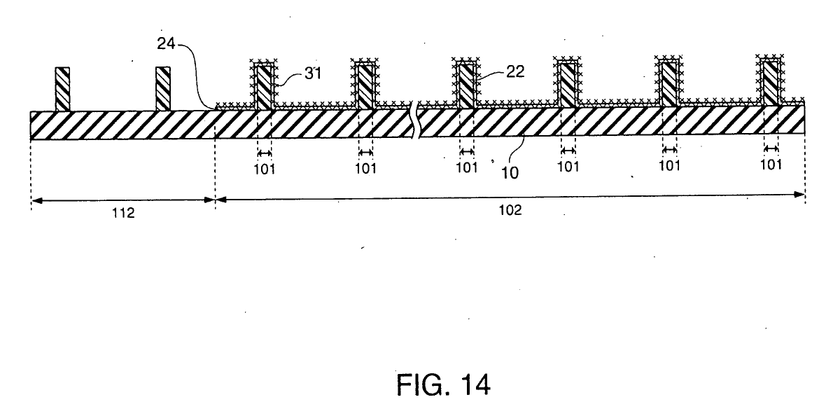

The light 20 is irradiated to the substrate 10 through a mask 16 (for example, a photomask). More specifically, the mask 16 is placed between the light source 18 and the substrate 10, and the light 20 is transmitted through portions of the mask 16 other than its light shielding portions 17 (for example, metal pattern portions composed of chromium or the like). The light shielding portions in accordance with the present embodiment are formed in a region other than the above-described region 112, in other words, in the region 102. The mask 16 may be disposed in contact with the catalyst layer 31 on the substrate 10. Also, the light irradiation step conducted in a nitrogen atmosphere is preferred as the light 20 is difficult to attenuate in the nitrogen atmosphere. In this manner, as shown in FIG. 14, the catalyst layer 31 and the catalyst adsorbing layer 24 in the second pattern can be formed in the region 102.

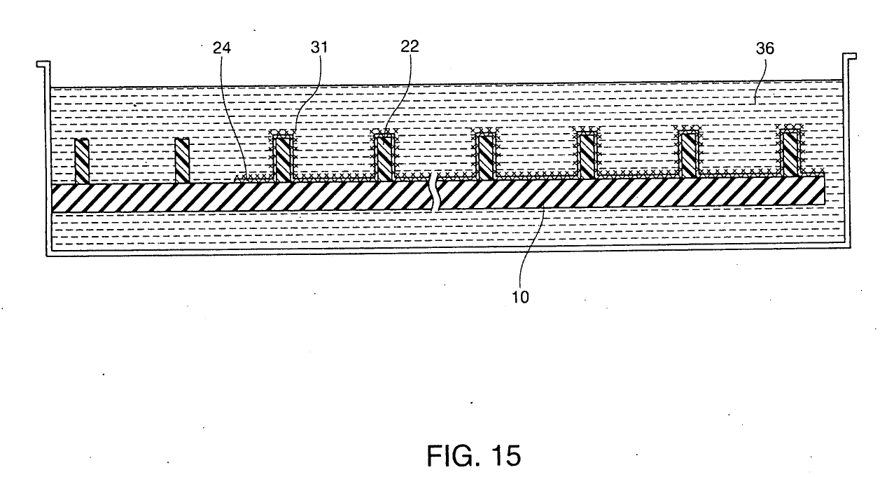

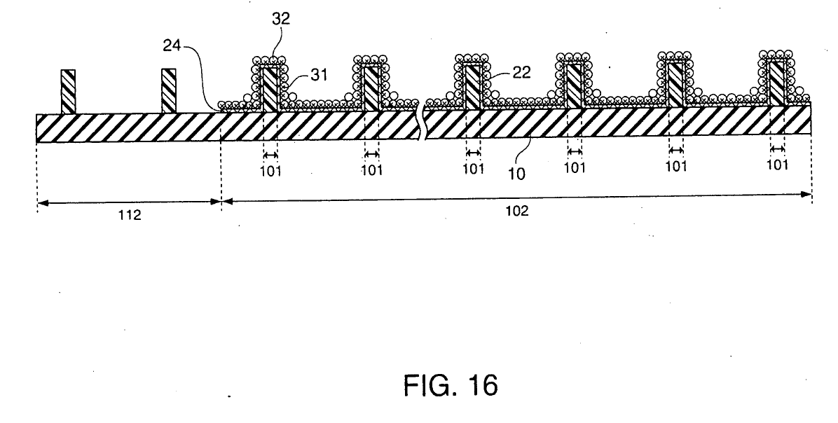

(7) Next, a metal layer 32 is deposited on the substrate 10 (see FIG. 16). The metal layer 32 is formed in the region where the catalyst layer 31 is formed. More concretely, as shown in FIG. 15, the substrate 10 is immersed in an electroless plating solution 36 containing metal, thereby depositing the metal layer 32.

The electroless plating solution 36 may preferably be adjusted such that the average particle diameter of plating particles is 20 nm or less, more preferably about 4 to 6 nm, when the plating particles are deposited on the substrate 10. By adjusting the size of plating particles to 4 to 6 nm, the metal particles composing the metal layer 32 would more readily be moved in a heat treatment step (8) to be described below. The electroless plating solution 36 can be adjusted by changing the pH, temperature, adjusting time and the like. The immersion time for which the substrate 10 is immersed in the electroless plating solution 36 exceeds a predetermined time, the average particle size of plating particles becomes to be 20 nm or greater, such that the immersion time may preferably be within the predetermined time.

The metal may be, for example, platinum. As the electroless plating solution 36, there are types of electroless plating solution used in an acidic region or in an alkaline region. As an example of the present embodiment, an electroless plating solution used in an alkaline region is used as the electroless plating solution 36. The electroless plating solution 36 includes the aforementioned metal, a reducing agent, a complexing agent, and the like. More concretely, as the electroless plating solution 36, a mixed solution in which a commercially available platinum plating liquid and a reducing agent are mixed, and the pH of the mixture is adjusted by sulfuric acid to pH 9.5 to pH 10.5 can be used. By immersing the substrate 10 in the mixed solution (at 40° C. to 50° C.) for about 5 minutes to 15 minutes, a platinum layer having a thickness of 10 nm to 40 nm is formed. The size of particles of the deposited platinum layer may preferably be about 4 nm to about 6 nm.

It is noted that the metal is not limited to platinum, and nickel or copper may also be used. In this manner, the metal layer 32 composed of particles can be formed. Also, after forming the metal layer 32, the substrate 10 may be washed with water. The substrate 10 may be washed with pure water, with steam, or with both of pure water and steam.

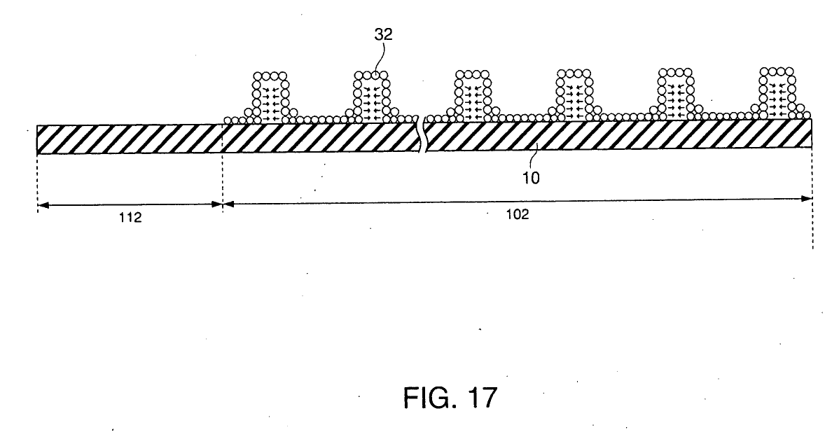

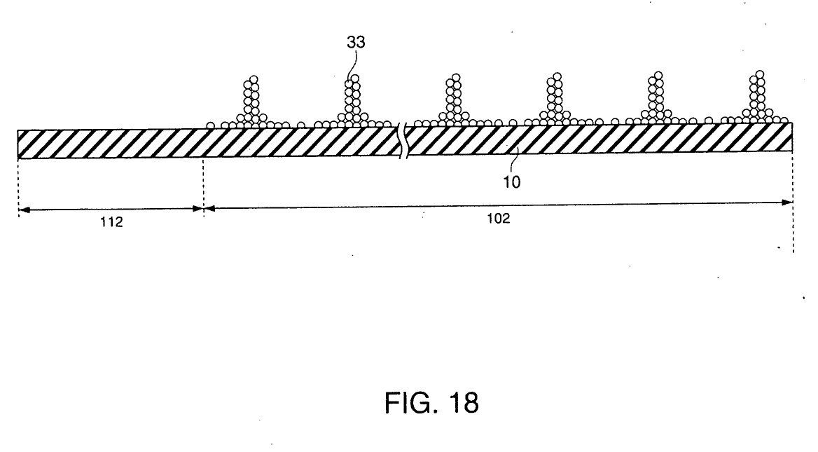

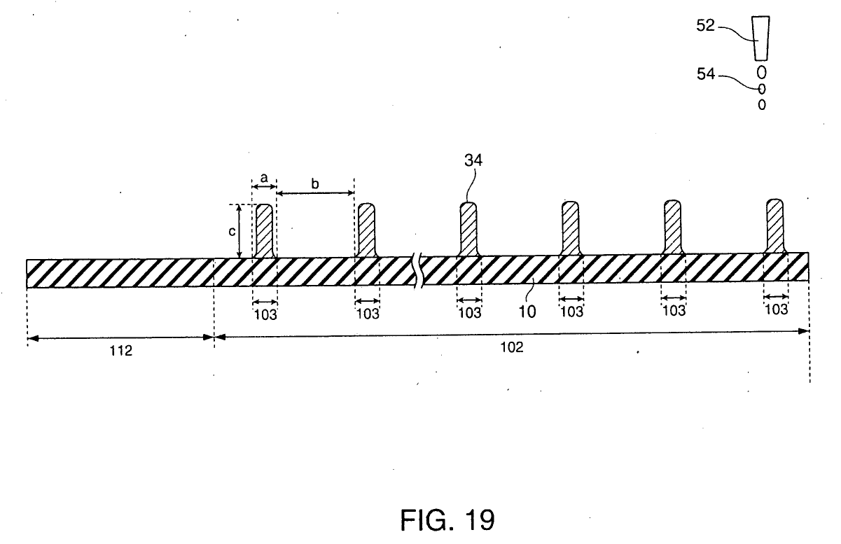

(8) Next, by heating the substrate 10, the sacrificial layer 22 is removed, and a first metal layer 34 in a third pattern is formed (see FIG. 19 and FIG. 20). The heat treatment may preferably be conducted by rapid thermal anneal (RTA) in an air-atmosphere at 300° C. to 700° C. for about 5 minutes to 30 minutes. In the heat treatment step, first, the sacrificial layer 22 is removed, as shown in FIG. 17. Along with the removal of the sacrificial layer 22, the metal particles composing the metal layer 32 aggregate in a manner to fill the forming region of the sacrificial layer 22, whereby a metal layer 33 in a configuration shown in FIG. 18 is formed. As the heating is continued, the metal particles are further aggregate in a manner to fill any gaps, whereby the first metal layer 34 with high metal density is formed, as shown in FIG. 19. At this time, the catalyst adsorbing layer 24 may be decomposed or may remain on the substrate 10, at the heating temperature.

FIG. 19 is a cross-sectional view taken along a line II-II in FIG. 20 in circled regions. Illustration of areas other than the circled regions is omitted. As shown in FIG. 19 and FIG. 20, first metal layers 34 in stripes can be formed in a local region 102 on the substrate 10.

The line width of the first metal layer 34 may be about two times the film thickness of the metal layer 32. Accordingly, by adjusting the film thickness of the metal layer 32, the line width of the metal layer 34 can be controlled. The film thickness of the metal layer 32 can be controlled by changing the immersion time for which the substrate 10 is immersed in the electroless plating solution 36, and the like. Also, the height of the metal layer 34 can be increased by increasing the height of the sacrificial layer 22. In this manner, the aspect ratio can be readily controlled by changing the height of the sacrificial layer 22 and the film thickness of the metal layer 32.

The stripe shape of the first metal layer 34 is defined by the aggregated metal particles that fill the forming region of the sacrificial layer 22, and therefore is in a shape that concurs with the stripe shape of the sacrificial layer 22. In other words, it can be said that the third pattern is a region where the region 101 in the first pattern and the region 102 in the second pattern overlap each other.

As described above, it is noted that the metal particles that form the metal layer 32 aggregate in the region where the sacrificial layer 22 is formed in the first pattern shape. Therefore, in the second pattern region 102, when the film thickness of the metal layer 32 is over a predetermined value, the third pattern region 103 is provided within the first pattern region 101; when the film thickness of the metal layer 32 is less than the predetermined value, the first pattern region 101 is provided within the third pattern region 103; and when the film thickness of the metal layer 32 is at the predetermined value, the first pattern region 101 concurs with the third pattern region 103. In other words, it can be said that the third pattern region 103 is a region where the second pattern region 104 and the first pattern region 101 overlap each other. The first pattern and the third patter have overlapping regions regardless of the film thickness of the metal layer 32. Accordingly, by forming the sacrificial layer 22 in a desired pattern, the metal layer 34 in the desired pattern can be formed.

(9) Next, droplets 54 of metal solution are discharged onto the substrate 10 by a droplet discharging method, and are hardened, whereby a second metal layer 50 in a fourth pattern is formed (see FIG. 1 and FIG. 2). The droplets 54 may be discharged by, for example, a dispenser method or an ink jet method. The dispenser method is commonly practiced as a method for discharging droplets, and is effective when the droplets 54 are discharged in a relatively wide area.

The ink jet method uses an ink jet head to discharge droplets, and is capable of controlling the position of discharging droplets in a unit in the order of μm. Also, the amount of a droplet to be ejected can be controlled in a unit in the order of picoliter. In this step, the ink jet method may be used for discharging droplets, whereby the second metal layer 50 having a very fine structure can be formed. FIG. 19 shows the step of discharging the droplets 54 through a nozzle 52 of the ink jet head against the substrate 10.

The metal solution is a solution containing fine particles of conductive metal. As the conductive metal, for example, gold, silver, copper, nickel and platinum can be used, without any particular limitation. The metal solution may further contain a dispersing agent (for example, alkylamine, carboxylic amide, amino carboxylate, and the like) and a solvent (for example, an organic solvent, such as, toluene, xylene, decarin and dodecane, alcohols, water and the like).

The droplets 54 are discharged in the following condition. The distance between the nozzle 52 and the substrate 10 is set to about 300 μm to 500 μm, the discharge frequency is set to about 10 kHz to 20 kHz, and the moving speed of the stage that supports the substrate 10 is set to about 20 mm/sec. In this step, the second metal layers 50 can be formed in desired regions 104 by moving the substrate 10 (see FIG. 2). However, instead, the droplets 54 may be discharged while moving the inkjet head having the nozzle 52.

The size of the second metal layer 50 can be controlled by adjusting the discharging amount of the droplets 54. Before discharging the droplets 54, a liquid-philic treatment or a liquid-repelling treatment may be applied to the top surface and side wall of the substrate 10 and the first metal layer 34 depending on the necessity, whereby the wettability of the surfaces with respect to the droplets 54 may be controlled.

(10) Next, the substrate 10 is heated, such that the metal fine particles on the substrate 10 are hardened, thereby forming a second metal layer 50. The heating may preferably be conducted by, for example, rapid thermal anneal (RTA), in an air-atmosphere, at 300° C. to 700° C. for about 5 minutes to 30 minutes. By this heating, the solvent of the metal solution discharged on the substrate 10 evaporates, and the metal fine particles can be crystallized, whereby the second metal layer 50 can be formed.

By the steps described above, a wiring substrate 100 is manufactured, as shown in FIG. 1 and FIG. 2. According to the method for manufacturing a wiring substrate 100 in accordance with the present embodiment, the line width a of the first metal layer 34 can be controlled by adjusting the film thickness of the metal layer 32, such that the first metal layer 34 in a highly accurate pattern can be formed without depending on the accuracy of the sacrificial layer 22. Also, in accordance with the present embodiment, metal layers can be formed only by a wet-process without requiring a vacuum apparatus, such that the manufacturing apparatus can be simplified, and cost reduction can be achieved. Also, in accordance with the present embodiment, local nano-wires and local micro-wires can be freely integrated in any patterns, such that the wires can be used as wires for small size electronic devices.

It is noted that, according to the method for manufacturing a wiring substrate 100 in accordance with the present embodiment, the catalyst layer 31 is formed first, and then patterned into the second pattern. Instead, after forming the catalyst adsorbing layer 24, the layer may be patterned into the second pattern, and then the catalyst layer 31 may be formed.

Also, the heating step in the step (8) may be omitted. By so doing, heating treatment may be conducted in the step (10), whereby the removal of the sacrificial layer 22 and the formation of the first metal layer 34 and the second metal layer 50 can be performed in a batch.

3. Modified Examples

A method for manufacturing a wiring substrate 200 in accordance with a modified example is described. The method for manufacturing a wiring substrate 200 in accordance with the modified example uses an electroless plating method to form second metal layers 50, and therefore is different from the method for manufacturing a wiring substrate 100 described above which uses a droplet discharge method to form the second metal layer 50.

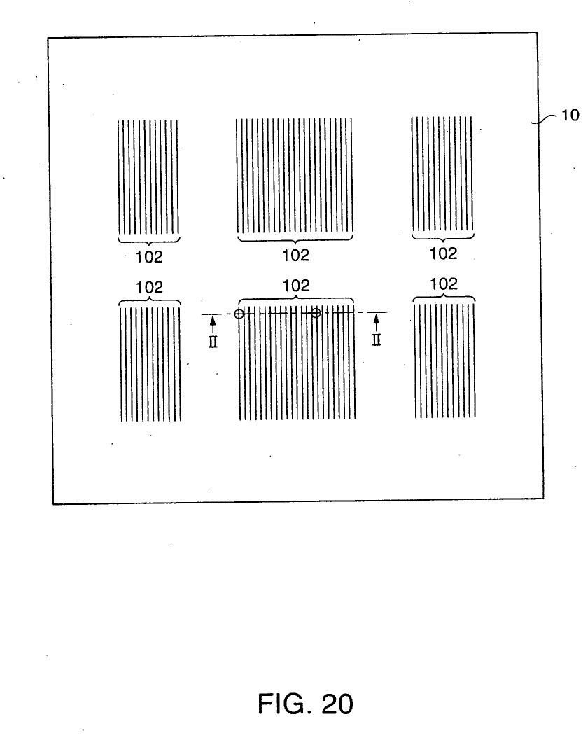

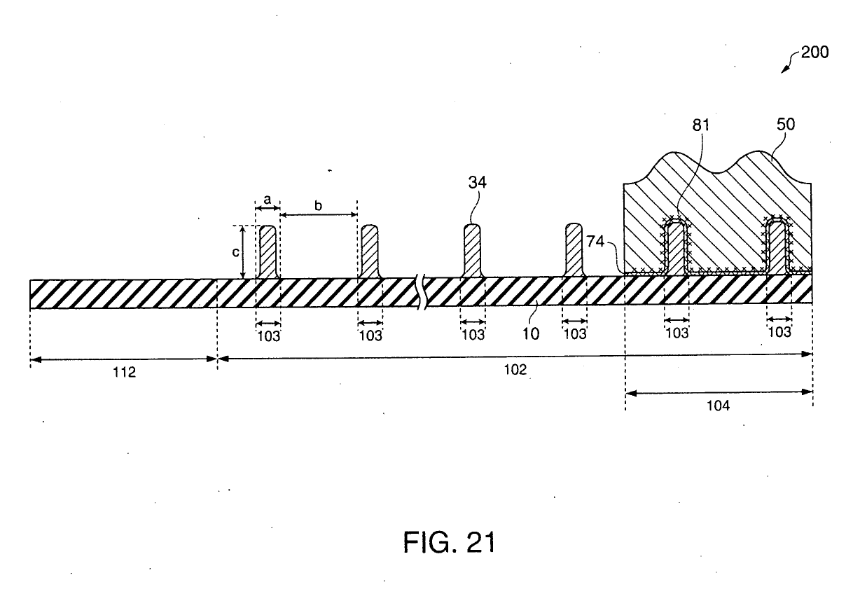

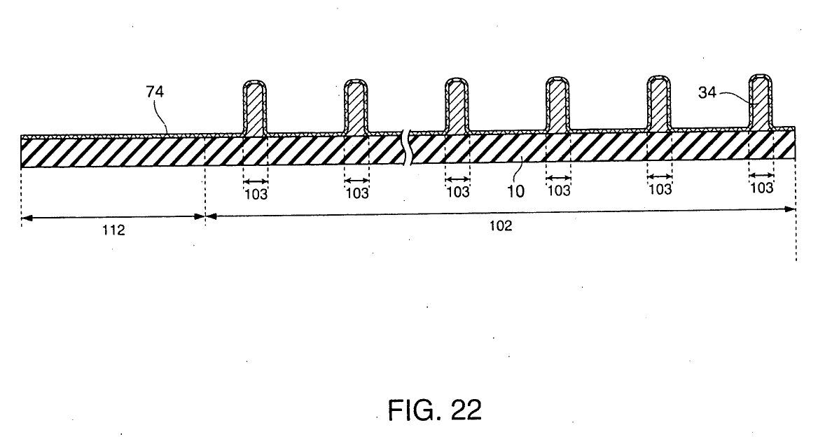

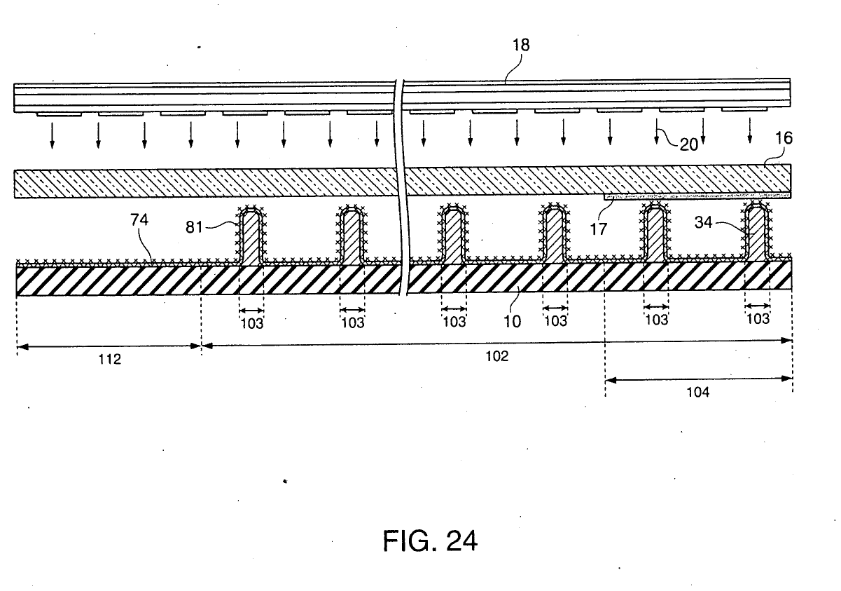

FIG. 21 is a schematic cross-sectional view of the wiring substrate 200 in accordance with the modified example. FIGS. 22-25 are views showing the method for manufacturing the wiring substrate 200 in accordance with the modified example. The method for manufacturing the wiring substrate 200 in accordance with the modified example is conducted as follows.

(1) First, the steps (1)-(8) in the method for manufacturing the wiring substrate 100 in accordance with the embodiment described above are conducted, thereby forming first metal layers 34 in a third pattern.

(2) Next, as shown in FIG. 22, a catalyst adsorbing layer 74 is formed over the entire surface of the substrate 10. The catalyst adsorbing layer 74 includes a surfactant or a silane coupling agent.

First, the substrate 10 is immersed in a catalyst adsorbing solution that contains a surfactant or a silane coupling agent dissolved therein. As the surfactant, a cationic surfactant or an anionic surfactant may be used. The immersion time may be, for example, about 1 minute to about 10 minutes.

Then, the substrate 10 is removed from the catalyst adsorbing solution 14, and washed with ultrapure water. Then, the substrate 10 may be, for example, naturally dried in room temperature, or droplets on its surface may be removed by blowing compressed air, and then placed and dried in an oven at 90° C. to 120° C. for about 10 minutes to about one hour. By the steps described above, the catalyst adsorbing layer 24 can be provided on the substrate 10, as shown in FIG. 22. At this moment, the surface potential in liquid of the substrate 10 is shifted more to the positive potential side than before the adsorption, when a cationic surfactant is used as the surfactant.

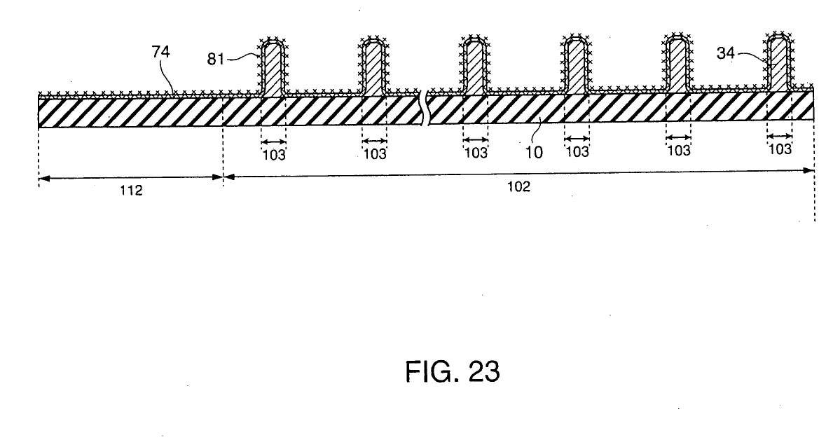

(3) Next, a catalyst layer 81 is formed on the catalyst adsorbing layer 74, as shown in FIG. 23. The catalyst layer 81 can be formed by immersing the substrate 10 in a catalyst solution. As the catalyst solution, the same catalyst solution as the catalyst solution 20 described above can be used, and therefore its description is omitted.

(4) Next, the catalyst layer 81 is patterned into a fourth pattern, thereby removing the catalyst layer 81 in regions other than the region 104. The patterning may be conducted by irradiating light to the regions other than the region 104, thereby decomposing the catalyst adsorbing layer 74.

As light 20 to be irradiated to the region 104, the vacuum ultraviolet radiation described above can be used, and therefore detailed description of the light 20 is omitted.

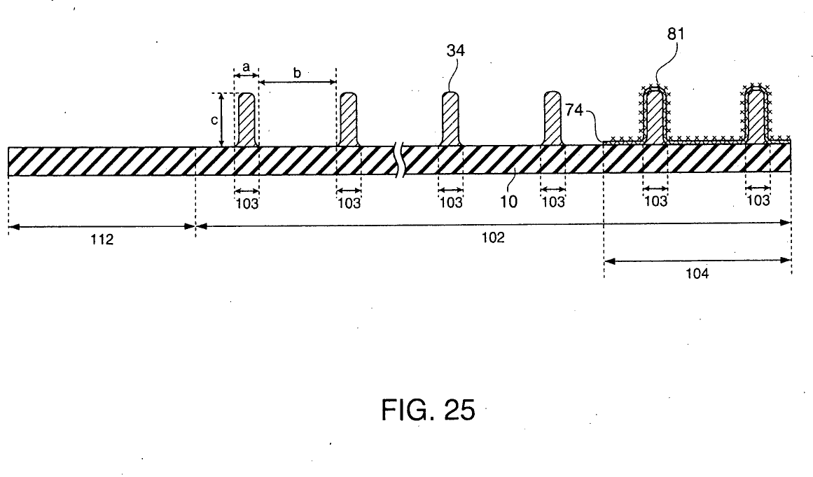

The light 20 is irradiated to the substrate 10 through a mask 16 (for example, a photomask). A light shielding section 17 in the modified example is formed in the region 104. The mask 22 may be disposed in contact with the catalyst layer 81 formed on the substrate 10. In this manner, the catalyst layer 81 and the catalyst adsorbing layer 74 in the second pattern can be formed in the region 102, as shown in FIG. 25.

(5) Next, a second metal layer 50 is deposited on the substrate 10 (see FIG. 21). The second metal layer 50 is formed in the region 104 where the catalyst layer 81 is formed. More concretely, the substrate 10 is immersed in an electroless plating solution containing metal, thereby depositing the second metal layer 50.

When a nickel layer is to be deposited as the second metal layer 50, an electroless plating liquid containing nickel (II) sulfate hexahydrate as a main composition and sodium hypophosphite as a reducing agent may be used. By immersing the substrate 10 in this electroless plating liquid (at 70° C. to 80° C.) for about one minute to about ten minutes, a nickel layer having a thickness of 0.1 μm to 1.0 μm can be formed. Alternatively, an electroless plating liquid containing nickel chloride hexahydrate as a main composition and sodium hypophosphite as a reducing agent may be used. For example, by immersing the substrate 10 in this electroless plating liquid (at 60° C. to 75° C.) for about five minute to about ten minutes, a nickel layer having a thickness of 0.1 μm to 1.0 μm can be formed. It is noted that the second metal layer 50 may be formed from any material without any particular limitation, as long as the material reacts with a catalyst, and may be formed from, for example, platinum (Pt), copper (Cu), or gold (Au). In this manner the second metal layer 50 can be formed on the substrate 10. The second metal layer 50 can be electrically connected to the first metal layer 34.

Depending on the material used for the first metal layer 34, the first metal layer 34 may itself function as a catalyst when forming the second metal layer 50. In this case, the surface of the first metal layer 34 may be covered by metal different from the material for the first metal layer 34, and thereafter the step (5) may be conducted. By this, when forming the second metal layer 50, metal can be prevented from depositing on the first metal layer 34.

Also, according to the method for manufacturing the wiring substrate 200 in accordance with the modified example described above, the catalyst layer 81 is first formed, and then patterned into the fourth pattern. Instead, the catalyst adsorbing layer 74 is first formed and then patterned into the fourth pattern, and thereafter the catalyst layer 81 may be formed.

4. Experimental Example

Next, an experimental example in accordance with the present embodiment is described. According to the experimental example, a platinum layer was formed as the first metal layer on the substrate. The following manufacturing process was conducted.

(1) A photoresist film was formed on a glass substrate, and then a direct drawing method is used to expose and develop the photoresist film in linear lines with a line width of about 70 nm at a pitch of about 140 nm, whereby a stripe shaped photoresist pattern having linear lines with a width of about 70 nm, at an interval of about 70 nm was formed.

(2) The glass substrate was cut into a 1×1 cm square, and then immersed in a cationic surfactant solution (FPD conditioner manufactured by Technic Japan Incorporated). Then, the glass substrate was immersed in a palladium catalyst solution, thereby forming a catalyst layer.

(3) Then, light was irradiated to the catalyst layer 31, thereby patterning the catalyst layer 31 in a second pattern. The light irradiation was conducted, using a vacuum ultraviolet lamp (wavelength: 172 nm, output: 10 mW, distance to sample: 1 mm), in a nitrogen atmosphere for 120 minutes to 180 minutes.

(4) Next, the glass substrate with the catalyst layer formed thereon was immersed in a platinum electroless plating liquid at 40° C. for about 15 minutes, whereby a platinum layer with a thickness of about 30 nm was formed in a region where the catalyst layer was formed. As the platinum electroless plating liquid, a mixed solution of a commercially available platinum plating liquid (manufactured by Daiken Chemical Co., Ltd.) and a commercially available reducing agent (manufactured by Daiken Chemical Co., Ltd.), whose pH was adjusted by sulfuric acid to about pH10, was used.

(5) Then, the glass substrate was washed with pure water at room temperature.

(6) Then, a heat treatment was conducted by RTA. The heat treatment was conducted in an air atmosphere at a heat treatment temperature of 550° C., for a heat treatment time of 10 minutes.

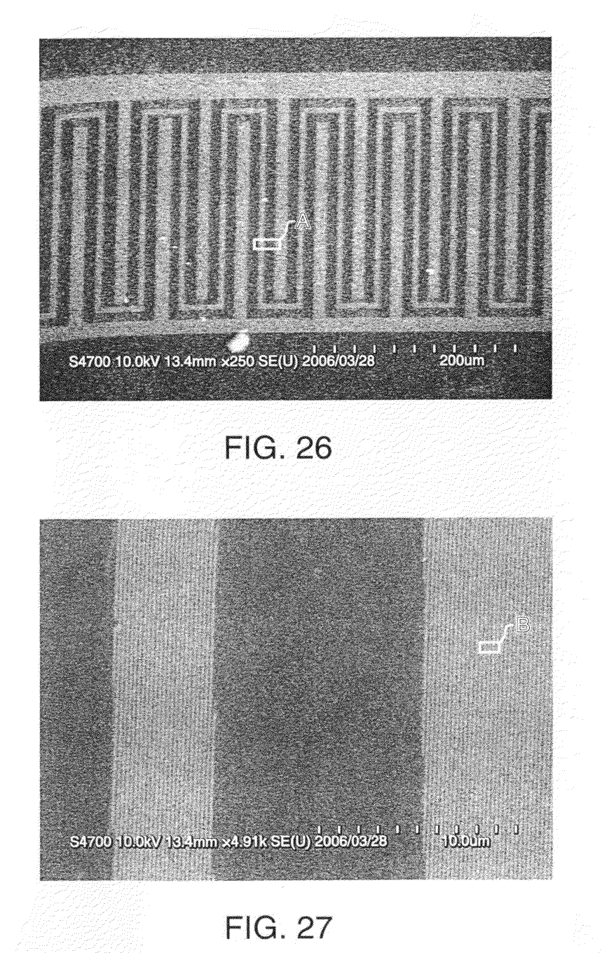

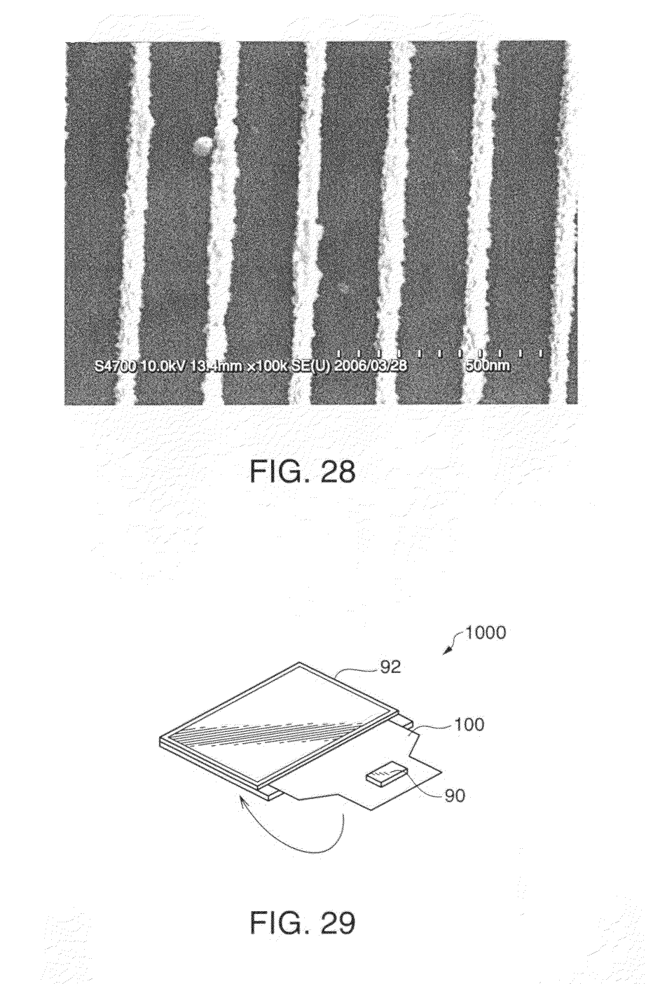

SEM images of the wiring substrate formed by the steps described above are shown in FIGS. 26-28. FIGS. 26-28 are images of the top surface of the wiring substrate. FIG. 27 is an enlarged image of a region A in FIG. 26, and FIG. 28 is an enlarged image of a region B of FIG. 27.

According to FIG. 26, it is confirmed that wirings are locally formed on the substrate. According to FIGS. 27 and 28, it is confirmed that the wirings were formed in a stripe pattern which is an aggregation of fine linear wirings. According to FIG. 28, it is confirmed that each of the fine wirings has a line width of about 50 nm.

5. Electronic Device

FIG. 29 shows an example of an electronic device that uses a wiring substrate 100 manufactured by the method for manufacturing a wiring substrate in accordance with the present embodiment. The electronic device 1000 includes the wiring substrate 100, an integrated circuit chip 90 and another substrate 92.

Wiring patterns formed on the wiring substrate 100 may electrically connect electronic components to one another. The wiring substrate 100 is manufactured by the above-described manufacturing method. In the example shown in FIG. 29, the wiring substrate 100 is electrically connected to an integrated circuit chip 90, and one end of the wiring substrate 100 is electrically connected to another substrate 92 (for example, a display panel). The electronic device 1000 may be a display device, such as, a liquid crystal display device, a plasma display device, an EL (electro luminescence) display device or the like.

Also, the wiring substrate 100, when formed as an optical wiring substrate, may function as a polarizing plate of a liquid crystal display device, a projector device or the like.

6. The invention is not limited to the embodiments described above, and many modifications can be made. Also, the invention may include compositions that are substantially the same as the compositions described in the embodiments (for example, a composition with the same function, method and result, or a composition with the same objects and result). Also, the invention includes compositions in which portions not essential in the compositions described in the embodiments are replaced with others. Also, the invention includes compositions that achieve the same functions and effects or achieve the same objects of those of the compositions described in the embodiments. Furthermore, the invention includes compositions that include publicly known technology added to the compositions described in the embodiments.

What is claimed is:

1. A method for manufacturing a wiring substrate comprising the steps of:
(a) forming a sacrificial layer in a first pattern on a substrate;
(b) forming a catalyst layer in a second pattern on the substrate;
(c) immersing the substrate in an electroless plating liquid, thereby depositing a metal layer on the catalyst layer in the second pattern; and
(d) heating to remove the sacrificial layer and to form a metal layer in a third pattern, wherein the third pattern is a region where the first pattern and the second pattern overlap each other.

2. A method for manufacturing a wiring substrate according to claim 1, wherein the step (b) includes forming a catalyst adsorbing layer including a surfactant or a silane coupling agent over the entire surface of the substrate, forming a catalyst layer on the catalyst adsorbing layer, irradiating light to a region other than the second pattern, thereby decomposing a portion of the catalyst adsorbing layer to form a catalyst layer in the second pattern.

3. A method for manufacturing a wiring substrate according to claim 1, wherein the step (b) includes forming a catalyst adsorbing layer including a surfactant or a silane coupling agent over the entire surface of the substrate, irradiating light to a region other than the second pattern, thereby decomposing a portion of the catalyst adsorbing layer to form a catalyst adsorbing layer in the second pattern, and forming a catalyst layer on the catalyst adsorbing layer.

4. A method for manufacturing a wiring substrate according to claim 1, further comprising, after the step (d), ejecting a metal solution onto the substrate by a droplet discharging method, and hardening the metal solution to form a metal layer in a fourth pattern, wherein the fourth pattern has a region that overlaps a portion of the third pattern.

5. A method for manufacturing a wiring substrate according to claim 1, further comprising, after the step (d), forming a catalyst layer in a fourth pattern, and immersing the substrate in an electroless plating liquid to deposit a metal layer in the fourth pattern, wherein the fourth pattern has a region that overlaps a portion of the third pattern.

6. A method for manufacturing a wiring substrate according to claim 5, wherein, before forming a catalyst layer in the fourth pattern, a surface of the metal layer in the third pattern is covered by a metal layer of a material different from a material of the metal layer in the third pattern.

7. A method for manufacturing a wiring substrate according to claim 1, wherein, in the step (d), the metal layer is moved by heating into the third pattern.

8. A method for manufacturing a wiring substrate according to claim 1, wherein, in the step (d), the sacrificial layer is decomposed and removed by heating.

9. A method for manufacturing a wiring substrate according to claim 1, wherein the first pattern and the third pattern include a stripe pattern having a plurality of linear lines, wherein each of the linear lines has a line width between 10 nm and 100 nm.

10. A method for manufacturing a wiring substrate according to claim 1, wherein the sacrificial layer is formed from resin.

11. A method for manufacturing a wiring substrate according to claim 10, wherein the step (a) includes coating a resin material in a flowable state on the substrate, pressing a nano-stamper having a concave pattern in the first pattern against the substrate, thereby transferring the first pattern to the resin material, and hardening the resin material.

12. A method for manufacturing a wiring substrate according to claim 10, wherein the sacrificial layer is formed from photoresist, and the sacrificial layer is formed by an interference exposure method in the step (a).

13. A method for manufacturing a wiring substrate comprising the steps of:
(a) forming a sacrificial layer in a first pattern on a substrate;
(b) forming a metal layer above a forming region and a non forming region of the sacrificial layer;
(c) heating to remove the sacrificial layer and form a metal layer in a third pattern; and
(d1) discharging a metal solution onto the substrate by a droplet discharging method, and hardening the metal solution to form a metal layer in a fourth pattern, wherein the third pattern is in a region of the first pattern, and the fourth pattern includes a part of a region of the third pattern.

14. A method for manufacturing a wiring substrate according to claim 13, wherein the step (b) includes immersing the substrate in a catalyst adsorbing solution including a surfactant or a silane coupling agent, thereby forming a catalyst adsorbing layer, and immersing the substrate in a catalyst solution, thereby forming a catalyst layer on the catalyst adsorbing layer.

15. A method for manufacturing a wiring substrate according to claim 13, wherein the metal layer is be moved by heating into the third pattern in the step (c).

16. A method for manufacturing a wiring substrate according to claim 13, wherein the sacrificial layer is decomposed and removed by heating in the step (c).

17. A wiring substrate having a metal layer formed by an electroless plating method, the wiring substrate comprising:
a substrate; and
a stripe pattern section formed on the substrate, the stripe pattern section having a plurality of linear first metal layers,
wherein the stripe pattern section is provided only in a partial region on the substrate, and the first metal layer has a line width between 10 nm and 100 nm.

18. A wiring substrate according to claim 17, further comprising a second metal layer that is adjacent to at least a portion of the first metal layer, and formed on a linear line having a line width between 10 μm and 100 μm.

19. A wiring substrate according to claim 17, wherein the first metal layer is formed from platinum.
